(19) United States
(12) Patent Application Publication
(10) Pub. No.: US 2026/0320295 A1
(43) Pub. Date: Oct. 15, 2026

(54) INFORMATION PROCESSING APPARATUS, CONTROL METHOD OF INFORMATION PROCESSING APPARATUS, AND STORAGE MEDIUM

(71) Applicant: CANON KABUSHIKI KAISHA, Tokyo (JP)

(72) Inventor: KEN SWYSEN, Tokyo (JP)

(21) Appl. No.: 19/691,061

(22) Filed: May 28, 2026

Related U.S. Application Data
(63) Continuation of application No. PCT/JP2024/041927, filed on Nov. 27, 2024.

(30) Foreign Application Priority Data
Dec. 4, 2023 (JP) 2023-204878

(51) Int. Cl. G06F 40/268; G10L 15/18

(52) U.S. Cl. CPC G06F 40/268; G10L 15/1815

(57) ABSTRACT

An information processing apparatus includes a processor, and a memory storing instructions that, when executed, cause the information processing apparatus to: acquire topic object information and morphological modification factor information based on utterance data indicating a user utterance, the topic object information indicating an object that is the topic, the morphological modification factor information being information that is included in the utterance content and modifies a morphology of the object, generate, based on the morphological modification factor information, a morphological modification parameter indicating a morphological feature of the object corresponding to the topic object information among objects in a target image of the user's utterance, make a modification to the object based on the morphological modification parameter; and control output of a result of the modification made to the object to a predetermined output destination.

### CROSS-REFERENCE TO RELATED APPLICATIONS

This application is a Continuation of International Patent Application No. PCT/JP2024/041927, filed Nov. 27, 2024, which claims the benefit of Japanese Patent Application No. 2023-204878, filed Dec. 4, 2023, both of which are hereby incorporated by reference herein in their entirety.

### BACKGROUND

### Field of the Technology

The present disclosure relates to an information processing apparatus, a control method of an information processing apparatus, and a storage medium.

### Description of the Related Art

Video conferencing has been utilized more frequently in recent years. An advantage of the use of video conferencing is that the accuracy of information transmission can be expected to be improved by visually sharing images among a plurality of users. In such a use case, persons in charge may align their understandings based on a shared image and by supplementing, through conversation, what modifications are to be made to the subject of the discussion shown by the image. Under the circumstances, various techniques have been discussed for generating a new image or modifying an existing image based on information about conversations taking place between persons in charge or text information input by persons in charge.

R. Rombach, “High-Resolution Image Synthesis with Latent Diffusion Models”, CVPR 2021, describes a technique for accepting text input called a prompt and generating and outputting a new image based on semantic information of the text. O. Patashnik, “StyleCLIP: Text-Driven Manipulation of StyleGAN Imagery”, ICCV 2021, describes a technique for accepting input of a base image and text information to modify the image, and outputting an image converted in style so that the modification indicated by the text information is applied thereto.

The technique described in R. Rombach generates images with plausible modifications based on the input text information, and the generated images therefore do not necessarily reflect the user's intentions accurately. Among examples of techniques for solving such an issue is the one described in O. Patashnik. However, the technique described in O. Patashnik needs successive preparation of text information for modifying images, which is burdensome for the user.

### SUMMARY

The present disclosure is directed to enabling reproduction of a morphology of an object indicated by the content of a user's utterance in a more suitable manner.

According to an aspect of the present disclosure, an information processing apparatus includes at least one processor, and at least one memory having stored thereon instructions which, when executed by the at least one processor, cause the information processing apparatus at least to: acquire topic object information and morphological modification factor information based on utterance data indicating an utterance content of a user's utterance, the topic object information indicating an object serving as a topic of the utterance content, the morphological modification factor information being information that is included in the utterance content and modifies a morphology of the object, generate, based on the morphological modification factor information, a morphological modification parameter indicating a morphological feature of the object corresponding to the topic object information among one or more objects included in a target image of the user's utterance, make a modification to the object based on the morphological modification parameter; and control output of a result of the modification made to the object to a predetermined output destination, wherein the morphological modification factor information includes at least one of an estimated likelihood of the object being the topic, applicability of the modification to the object, and information about the user making the utterance indicated by the utterance content.

Features of the present disclosure will become apparent from the following description of embodiments with reference to the attached drawings.

### BRIEF DESCRIPTION OF THE DRAWINGS

FIG. 1 is a diagram illustrating an example of a hardware configuration of an information processing apparatus.

FIG. 2 is a diagram illustrating an example of a functional configuration of the information processing apparatus.

FIG. 3 is a flowchart illustrating an example of processing by the information processing apparatus.

FIG. 4 is a diagram illustrating an example of a display screen of the information processing apparatus.

FIG. 5 is a diagram illustrating an example of a display state of the display screen.

FIG. 6 is a flowchart illustrating an example of processing by the information processing apparatus.

FIG. 7 is a diagram illustrating an example of the display state of the display screen.

FIG. 8 is a flowchart illustrating an example of processing by the information processing apparatus.

FIG. 9 is a flowchart illustrating an example of processing by the information processing apparatus.

FIG. 10 is a flowchart illustrating an example of processing by the information processing apparatus.

FIGS. 11A to 11C are schematic diagrams each illustrating an example of a detection likelihood map.

FIGS. 12A to 12D are diagrams each illustrating an example of the display screen of the information processing apparatus.

FIG. 13 is a diagram illustrating an example of a functional configuration of an information processing apparatus.

FIG. 14 is a flowchart illustrating an example of processing by the information processing apparatus.

FIGS. 15A to 15C are diagrams each illustrating an example of an update result of the morphology of a topic object.

FIG. 16 is a diagram illustrating an example of a display screen of the information processing apparatus.

FIGS. 17A to 17C are diagrams each illustrating an example of the display screen of the information processing apparatus.

### DESCRIPTION OF THE EMBODIMENTS

Hereinafter, preferred embodiments of the present disclosure will be described in detail with reference to the accompanying drawings.

In the present specification and the drawings, constituent elements having substantially the same functional configuration are denoted by the same reference numerals, and redundant description thereof will be omitted.

### First Embodiment

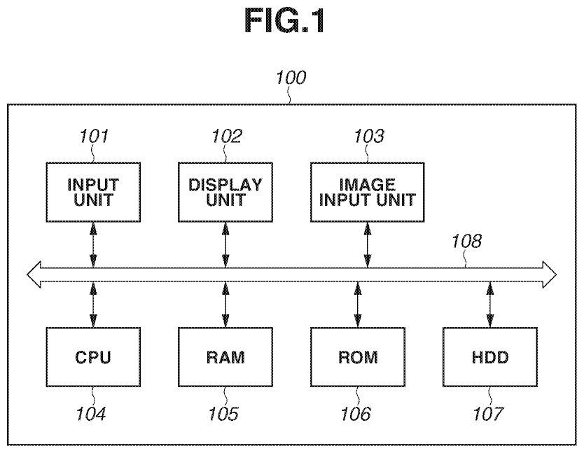

A first embodiment of the present disclosure will now be described. FIG. 1 is a diagram illustrating an example of a hardware configuration of an information processing apparatus according to the present embodiment.

An information processing apparatus 100 includes a central processing unit (CPU) 104, a random access memory (RAM) 105, and a read-only memory (ROM) 106. The information processing apparatus 100 also includes an input unit 101, a display unit 102, an image input unit 103, and a hard disk drive (HDD) 107. The foregoing components of the information processing apparatus 100 are connected via a data bus 108 in a manner capable of transmitting and receiving data to/from each other.

The CPU 104 reads a control computer program stored in the ROM 106, loads the control computer program into the RAM 105, and performs various types of control processing based on the program. The RAM 105 is used as an area for loading programs to be executed by the CPU 104, a temporary storage area such as a work memory, and the like.

The image input unit 103 serves as an interface for receiving image data from outside. Examples of the method for receiving image data include receiving image data from an external device such as an imaging apparatus via a transmission line such as a cable, receiving image data from another apparatus over a network such as the Internet, and receiving image information displayed on a display unit.

The HDD 107 stores various types of data such as image data and setting parameters, as well as various programs and the like.

The image data received via the image input unit 103 is transmitted to the CPU 104, the RAM 105, and the ROM 106 via the data bus 108.

The CPU 104 also executes an information processing program stored in the ROM 106 or the HDD 107, whereby image processing on input data (such as image data) is performed.

Data received from external apparatuses via the image input unit 103 may also be stored in the HDD 107.

The input unit 101 serves as an input interface for accepting information input from the user. For example, the input unit 101 may include input devices such as a keyboard, a mouse or other pointing device, and a touchscreen. The input unit 101 may also include an audio input device such as a microphone.

The display unit 102 serves as an output interface for presenting information to the user. For example, the display unit 102 may include a display device such as a liquid crystal display.

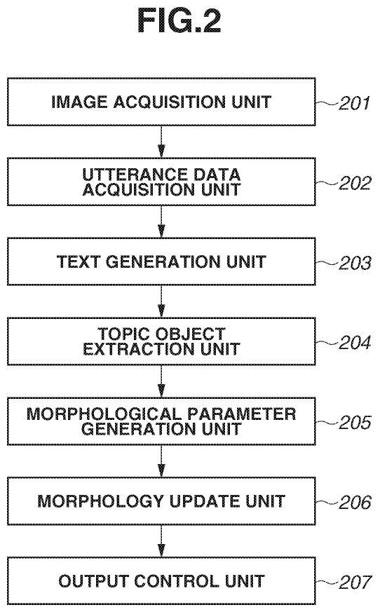

An example of a functional configuration of the information processing apparatus 100 according to the present embodiment will be described with reference to FIG. 2.

The information processing apparatus 100 according to the present embodiment includes an image acquisition unit 201, an utterance data acquisition unit 202, a text generation unit 203, a topic object extraction unit 204, a morphological parameter generation unit 205, a morphology update unit 206, and an output control unit 207.

The image acquisition unit 201 acquires image data to be processed. The image data to be processed may be image data acquired by an external device such as an imaging apparatus, image data stored in a storage device such as a hard disk, or image data received via a network such as the Internet. The image acquisition unit 201 outputs the acquired image data to the topic object extraction unit 204.

The utterance data acquisition unit 202 acquires utterance data indicating the utterance content of a user (speaker). The utterance data is data that includes information indicating the user (speaker) as metadata (hereinafter, also referred to as user information) and indicates the utterance content of the user as text information. The number of users to acquire utterance data from is not limited in particular, as long as there is at least one user. In a case where there is a plurality of target users, utterance data may be acquired user by user. In such a case, which user's utterance content each piece of utterance data represents is identifiable from the foregoing user information.

The method for acquiring text information indicating the user's utterance content included in the utterance data is not limited in particular. For example, text information indicating the user's utterance content may be acquired based on text data input by the user via an input device such as a keyboard.

As another example, a user's voice input via a sound collection device such as a microphone may be converted into text data, and text information indicating the user's utterance content may be acquired based on the text data.

The acquisition of text information indicating a user's utterance content using the foregoing various input interfaces may be performed in real time in synchronization with the information processing apparatus 100, or may be performed by reading out data stored in advance. The method for acquiring source data of the text information indicating the user's utterance content (for example, text data, voice data, and the like) is not limited in particular, either. For example, target data may be acquired from an external device connected via a transmission line such as a cable. Target data may be acquired from an external device via a network.

In addition to the text information indicating the user's utterance content and the user information, the utterance data may further include a time of utterance or other information indicating the point at which the target utterance is made in a series of utterances (for example, a point on a time series, a point in a context, etc.) as metadata. Since such information indicating the point where the target utterance is made in a series of utterances is included as metadata, the user's utterance content indicated by the utterance data is able to be segmented into clauses and managed in association with the order of the clauses. For the sake of convenience, the following various descriptions will be given on the assumption that the time of utterance is applied as the information indicating the point where the target utterance is made in a series of utterances.

The utterance data acquisition unit 202 outputs the acquired utterance data to the text generation unit 203.

The text generation unit 203 generates topic object information and morphological modification factor information based on the utterance data. Each of the topic object information and the morphological modification factor information will now be described in more detail.

The topic object information is information about an object (for example, an object or the like in an image) mentioned as the topic of the utterance content indicated by the utterance data. For example, the topic object information may be configured as structured data including information such as the name of the object serving as the topic of the utterance content, an estimated likelihood of the object being the topic, and the corresponding time of utterance in the utterance data. As another example, the topic object information may be configured as a list including one or more pieces of the foregoing structured data. As will be detailed below, when uniquely determining a topic object, the topic object extraction unit 204 may refer to the estimated likelihood of being the topic in the context indicating the user's utterance content.

The morphological modification factor information is information about modification of the morphology of the topic object mentioned in the utterance content indicated by the utterance data, and may correspond to information about a proposal for modification of the morphology of the topic object. Modifying a morphology corresponds to, for example, applying processing such as addition, duplication, deletion, movement, and modification to the shape or appearance such as color and texture.

For example, the morphological modification factor information may include information such as a summary name of the morphological modification factor, the name of the linked topic object, an estimated likelihood of being a morphological modification factor, the corresponding time of utterance in the utterance data, user information (proposer), a state related to applicability of the morphological modification, and an attribute of the morphological modification factor. The morphological modification factor information may be a list of structured data including the foregoing pieces of information.

A morphological modification factor is linked with a topic object. A plurality of morphological modification factors may be linked with a topic object. For example, it is commonly conceivable that multiple modifications are made to different portions of a morphology. In such a case, morphological modification factors corresponding to the modifications to the respective portions are linked with the morphology of the topic object.

The estimated likelihood of being a morphological modification factor is a likelihood indicating whether the target expression (uttered information) is one typically related to modifying a morphology. For example, in a case where the morphological modification factor is an expression “round the corners”, which is typically interpreted as an expression related to modifying a morphology, a higher value of likelihood is output. On the other hand, in a case where the morphological modification factor is an expression “rotate gently”, which is typically not interpreted as an expression describing or modifying a morphology, a low value of likelihood is output.

The state related to the applicability of the morphological modification is information indicating, when an utterance regarding applicability of the target morphological modification is made in a series of utterances (for example, a series of utterances made in a discussion among users), the applicability of the morphological modification based on the utterance. For example, a first user proposes a morphological modification to a topic object and then a second user utters disapproval of the morphological modification. In such a situation, the text generation unit 203 extracts the morphological modification factor indicating the morphological modification based on the foregoing utterance made by the first user, and also extracts the positive or negative decision about the application of the morphological modification based on the foregoing utterance made by the second user. The state related to the applicability of the morphological modification may be expressed as a true/false value of 0 or 1, or as a numerical value.

The attribute of a morphological modification factor is information indicating which of a plurality of modifications the target modification processing makes to the morphology of the topic object, including addition, deletion, and modification. The attribute of a morphological modification factor is referred to, for example, when the morphological parameter generation unit 205 to be described below branches into different processes depending on the attribute.

The text generation unit 203 may be implemented, for example, by a neural network-based natural language generation model capable of processing a context of sufficient length. Applying this configuration enables processing of text-to-text conversion tasks such as generation of topic object information and morphological modification factor information from input utterance data. It will be understood that the foregoing is merely an example, and the method is not limited in particular as long as information corresponding to topic object information and morphological modification factor information is extracted or generated from the utterance content indicated by the input utterance data.

The text generation unit 203 outputs the topic object information among the series of generated data to the topic object extraction unit 204, and the morphological modification factor information to the morphological parameter generation unit 205.

Based on the image data acquired by the image acquisition unit 201 and the topic object information generated by the text generation unit 203, the topic object extraction unit 204 extracts the object indicated by the topic object information in the image represented by the image data. In the following description, for the sake of convenience, the object indicated by the topic object information may be referred to as a topic object. The result of extraction of the topic object by the topic object extraction unit 204 includes, for example, an image of the topic object included in the image represented by the image data (a partial image of the region of the topic object) and position information about the position where the topic object is in the image.

The method for extracting the image of the topic object from the image represented by the image data is not limited in particular. For example, a method for cutting out the region of the topic object along its contour by segmentation may be applied. A method for cutting out a rectangle enclosing the region of the topic object may be applied. The position information about the topic object may be defined as position information about the rectangle enclosing the region of the topic object, for example.

In a case where the topic object information is a list of a plurality of pieces of structured data, the topic object extraction unit 204 uniquely identifies a piece of topic object information having a higher likelihood included therein as metadata. The topic object extraction unit 204 then may output the result of extraction of the topic object based on the identified topic object information. With such control applied, when there is a plurality of topic object candidates, the object most likely to be the topic object among the plurality of candidates are extracted, and the other objects are filtered (excluded from the extraction targets).

If, for example, all the estimated likelihoods included in the topic object information are lower than a certain value (threshold), the topic object extraction unit 204 may determine that there is no topic object.

As another example, the topic object extraction unit 204 may determine that there is no topic object in a case where a statistic of likelihoods during segmentation in the result of extraction of the topic object is less than a certain value (threshold). This processing is intended for cases where no topic object is included in the utterance data, which may correspond to situations where there is no relevance (or extremely low relevance) between the target image data and the user's utterances. As a specific example, this may correspond to a situation where a conversation irrelevant to the target image data is taking place among users to acquire utterance data from.

The topic object extraction unit 204 may be implemented, for example, by a neural network-based model capable of executing a task of searching for and extracting an object corresponding to specified text from within an image. The model applied to the topic object extraction unit 204 is desirably one trained based on pairs of large-scale natural language data and image data, so that high extraction accuracy is attained for a wide variety of topic objects even in a zero-shot manner. Zero-shot corresponds to executing a task on a label having a novel class that the model has not learned.

The topic object extraction unit 204 outputs the result of extraction of the topic object to the morphological parameter generation unit 205 and the morphology update unit 206.

The morphological parameter generation unit 205 generates morphological modification parameters based on the morphological modification factor information generated by the text generation unit 203 and the result of extraction of the topic object by the topic object extraction unit 204.

Morphological modification parameters are parameters representing morphological features based on morphological modification factor information.

Specifically, morphological modification parameters are structured data including geometric morphological information such as position, size, shape, and orientation of a morphological feature generated based on morphological modification factors, and appearance information such as color and texture. The morphological modification parameters may inherit part or all of the structured information about the morphological modification factors from which they are generated.

The morphological parameter generation unit 205 may be implemented, for example, by a neural network with multimodal inputs that inputs text and an image and outputs the foregoing structured data.

Of the morphological modification parameters representing morphological features, parameters such as the position and size are restricted by the morphology of the topic object to be input, particularly contour information thereof. Such parameters are therefore desirably controlled by the topic object image. This respect will now be described by citing a specific example.

For example, a morphological modification factor “add bolt holes” is input in each of cases where the width of the topic object is 30 mm and where the width is 1000 mm. Since the morphological modification factor does not include a size-related modifier in particular, a “normal” setting indicating a commonly applied size is employed for the size in the morphological modification parameters. On the other hand, users typically consider that a “bolt hole” diameter of approximately 10 mm or less is for a 30-mm-wide morphology, and approximately 50 mm or less is for a 1000-mm-wide morphology. It is difficult, however, for the morphology update unit 206 described below to accommodate such variations in the size of the morphological feature to be generated between 10 mm and 50 mm when the size specification “normal” is given by the morphological modification parameter. In view of such a situation, the morphological parameter generation unit 205 may control the morphological modification parameters to be generated, using information about the topic object image and the like.

The morphological parameter generation unit 205 may perform different tasks depending on the attribute of the input morphological modification factor information. For example morphological modification factor information having an attribute indicating addition of a morphological feature to the morphology of the topic object, such as “add bolt holes to a flat portion”, is input. In this case, the morphological parameter generation unit 205 may perform, for example, a task of detecting a flat portion from the topic object image and a task of outputting map information about locations where bolt holes may be added, and determine morphological modification parameters such as the positions and size of bolt holes to be added. In another example, morphological modification factor information having an attribute indicating deletion of a morphological feature from the morphology of the topic object, such as “delete bolt holes from a flat portion”, is input. In this case, the morphological parameter generation unit 205 may perform only a task of detecting bolt holes in a flat portion from the topic object image, for example.

The morphological parameter generation unit 205 outputs the generated morphological modification parameters to the morphology update unit 206.

The morphology update unit 206 makes at least one of a plurality of modifications including addition, modification, and deletion of morphological features to the topic object extracted by the topic object extraction unit 204, based on the morphological modification parameters generated by the morphological parameter generation unit 205.

The morphology update unit 206 may be implemented, for example, by a diffusion neural network model for performing image generation, trained to minimize the distance in feature space between the original image and the generated image so that morphological features of the original topic object are preserved.

The morphology update unit 206 then outputs the morphology of the topic object updated by making modifications to the topic object based on the morphological modification parameters (hereinafter, also referred to as an updated morphology) to the output control unit 207.

The output control unit 207 controls output of information indicating the morphology of the topic object modified by the morphology update unit 206 (i.e., the updated morphology of the topic object) to a predetermined output destination.

For example, the output control unit 207 may display the updated morphology of the topic object in a predetermined display area (for example, the display unit 102). Here, the output control unit 207 may display the image represented by the image data acquired by the image acquisition unit 201, the utterance data acquired by the utterance data acquisition unit 202, and the updated morphology of the topic object in respective predetermined display areas. In this case, the output control unit 207 may selectively switch whether the respective pieces of information described above may be displayed, based on the user's specifications. Furthermore, the output control unit 207 may perform interactive processing on the updated morphology of the topic object displayed in a predetermined display area, based on instructions from the user via the input unit 101. An example of the interactive processing will be separately described in detail below.

The foregoing is merely an example, and the output destination of the information indicating the updated morphology of the topic object by the output control unit 207 is not limited thereto. As a specific example, the output control unit 207 may output the information indicating the updated morphology of the topic object to an apparatus that applies various types of image processing or various types of analysis processing to target data, as a target of the image processing or the analysis processing.

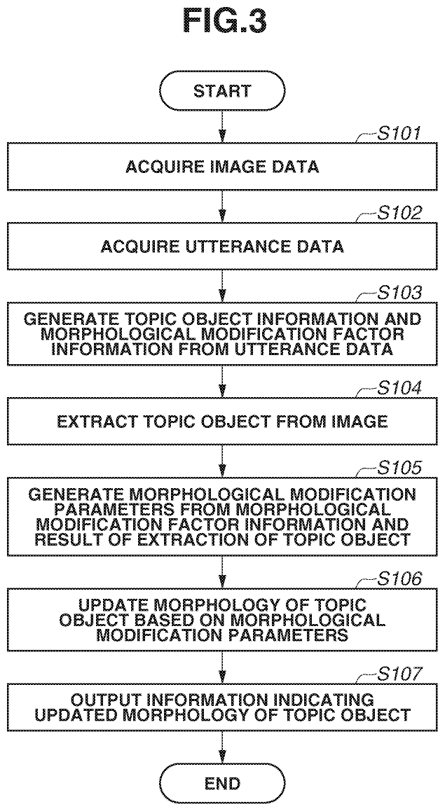

An example of processing by the information processing apparatus 100 according to the present embodiment will be described with reference to FIG. 3.

In step S101, the image acquisition unit 201 acquires image data to be processed.

In step S102, the utterance data acquisition unit 202 acquires utterance data indicating the user's utterance content input via a predetermined input interface. The utterance data acquisition unit 202 may acquire utterance data based on the utterances of each of a plurality of users, not necessarily only one user.

In step S103, the text generation unit 203 generates topic object information and morphological modification factor information based on the utterance data acquired in step S102.

In step S104, based on the image data acquired in step S101 and the topic object information generated in step S103, the topic object extraction unit 204 extracts the topic object indicated by the topic object information in the image represented by the image data.

In step S105, the morphological parameter generation unit 205 generates morphological modification parameters based on the morphological modification factor information generated in step S103 and the result of extraction of the topic object in step S104.

In step S106, the morphology update unit 206 makes modifications to the topic object extracted in step S104, by adding, modifying, or deleting morphological features based on the morphological modification parameters generated in step S105. The morphology of the topic object is thereby updated.

In step S107, the output control unit 207 controls the output of the information indicating the morphology of the topic object modified in step S106 (i.e., the updated morphology of the topic object) to a predetermined output destination. As a specific example, the output control unit 207 may present the updated morphology of the topic object to the user by displaying the updated morphology in a predetermined display area.

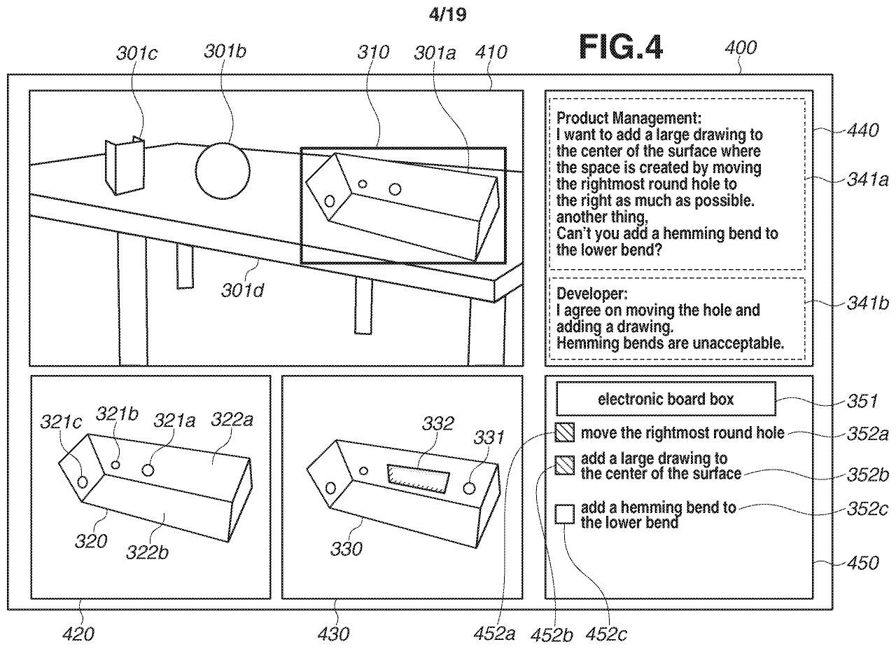

An example of a screen that the information processing apparatus 100 according to the present embodiment presents to the user via the display unit 102 will be described with reference to FIG. 4. FIG. 4 illustrates a display screen 400, which includes a target image display section 410, a topic object image display section 420, an update result display section 430, an utterance content display section 440, and a morphological modification factor display section 450.

The target image display section 410 is a display area where the image represented by the image data acquired by the image acquisition unit 201 is displayed.

In the example illustrated in FIG. 4, four objects are captured as objects in the image: an electronic board box 301a, a sphere 301b, a reinforcing plate 301c, and a workbench 301d. In the example illustrated in FIG. 4, for the sake of convenience, the electronic board box 301a is determined as the topic object based on a user's utterance input accepted in advance. In the example illustrated in FIG. 4, to clearly indicate the result of extraction of the topic object, a rectangular box 310 (bounding box) is displayed to enclose the region of the electronic board box 301a in the image displayed in the target image display section 410. The target image display section 410 corresponds to an example of a first partial area.

The utterance content display section 440 is a display area where users' utterance content indicated by the utterance data acquired by the utterance data acquisition unit 202 is displayed. In the example illustrated in FIG. 4, utterances 341a and 341b corresponding to respective two pieces of utterance data are displayed as arranged in chronological order, with the older one presented above and the newer one below. As described above, the utterance data includes text data indicating the utterance content and information indicating the speakers of the target utterances. The utterances 341a and 341b are displayed based on the text information indicating the utterance content included in the respective target pieces of utterance data.

In the example illustrated in FIG. 4, the utterance 341a makes three proposals: “add a large drawing to the center of the surface where the space is created by moving a round hole”, “move the rightmost round hole to the right as much as possible”, and “add a hemming bend to the lower bend”. In response to these proposals, the utterance 341b agrees with the first and second proposals and rejects the third.

The morphological modification factor display section 450 is a display area where the morphological modification factors indicated by the morphological modification factor information generated based on the utterance data are displayed. A topic object name included in the topic object information determined as a target is displayed in a display area 351 in the morphological modification factor display section 450. Summary names included in the morphological modification factor information associated with the topic object are also displayed in the morphological modification factor display section 450.

In the example illustrated in FIG. 4, summary names 352a, 352b, and 352c corresponding to respective three pieces of morphological modification factor information are displayed. Furthermore, checkboxes 452a, 452b, and 452c are displayed in association with the respective three pieces of morphological modification factor information. The checkboxes 452a, 452b, and 452c reflect the results of estimation made by the text generation unit 203 of the states related to the applicability of morphological modification (making modifications to the object) for the respective pieces of morphological modification factor information.

In the example illustrated in FIG. 4, the proposal represented by the summary name 352c, “add a hemming bend to the lower bend”, is rejected by the utterance 341b. For this proposal, the applicability status of the morphological modification factor is thus set to “no”, and the checkbox 452c is displayed OFF. On the other hand, the proposals corresponding to the summary names 352a and 352b are agreed upon in the utterance 341b. For these proposals, the applicability statuses of the morphological modification factors are thus set to “yes”, and the respective checkboxes 452a and 452b are displayed ON.

Each of the checkboxes 452a, 452b, and 452c may be freely switched ON and OFF based on instructions from the user via the input unit 101. Changing the states related to the applicability of the morphological modification factors via the checkboxes 452a, 452b, and 452c may trigger processing for making modifications to the updated morphology of the topic object displayed in the update result display section 430.

The topic object image display section 420 is a display area where the image of the topic object extracted from the acquired image data is displayed based on the result of extraction of the topic object. In the example illustrated in FIG. 4, the image of the electronic board box 301a determined as the topic object (a topic object image 320) is extracted from the image represented by the acquired image data and is displayed. The topic object image display section 420 corresponds to an example of a second partial area.

The update result display section 430 is a display area that displays the image of the morphology of the topic object modified by performing addition, modification, and/or deletion of morphological features on the topic object based on the morphological modification factors (the image of the updated morphology of the topic object). In the example illustrated in FIG. 4, the result of the two modifications made to the topic object image 320, “move the rightmost round hole to the right as much as possible” and “add a large drawing to the center of the surface”, is displayed as an updated morphology 330. The update result display section 430 corresponds to an example of a third partial area.

The display of the components constituting the display screen 400 (the display sections denoted by the reference numerals 410 to 450) may be individually and freely switchable ON and OFF based on instructions from the user.

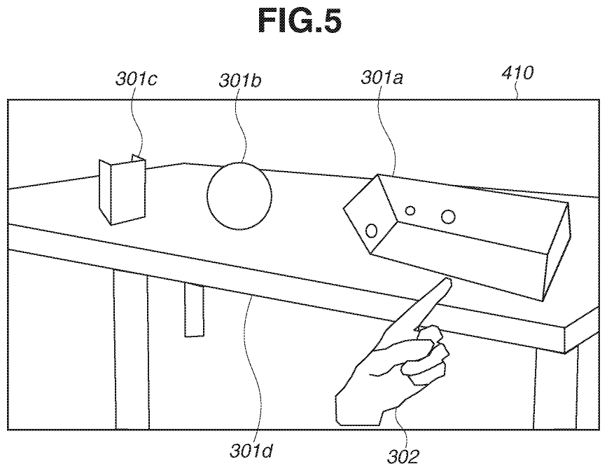

FIG. 5 is a schematic diagram illustrating an example of a display state of the target image display section 410 in the display screen 400 illustrated in FIG. 4. Specifically, FIG. 5 schematically illustrates a situation where a hand 302 is captured as another object in addition to the objects 301a to 301d that are candidates for the topic of the users' utterance content.

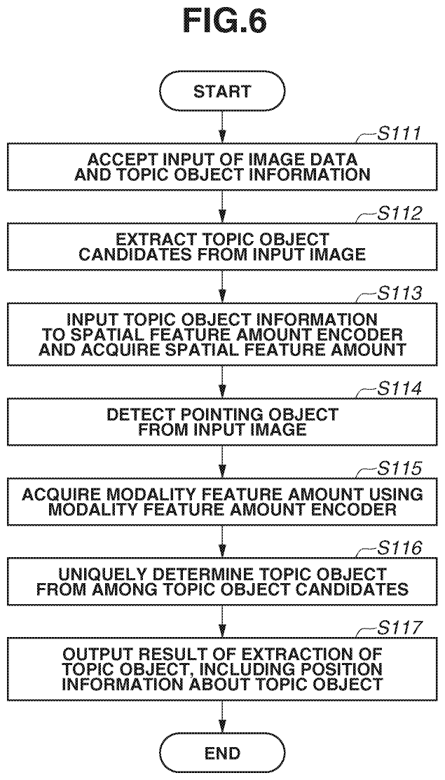

An example of processing by the topic object extraction unit 204 will now be described with reference to FIG. 6, by using the situation illustrated in FIG. 5 as an example. To improve the estimation accuracy of the topic object in the image, the topic object extraction unit 204 uses feature amounts that are extracted from the image, such as a spatial feature amount and a modality feature amount.

In step S111, the image acquisition unit 201 accepts input of image data to be processed from the user. The utterance data acquisition unit 202 acquires utterance data indicating the user's utterance content. The text generation unit 203 generates topic object information and morphological modification factor information based on the utterance data acquired by the utterance data acquisition unit 202.

In step S112, the topic object extraction unit 204 extracts topic object candidates indicated by the topic object information from the image indicated by the image data (hereinafter, may be referred to as an input image) based on the image data and the topic object information acquired in step S111.

In the example illustrated in FIG. 5, in a case where the acquired topic object name is “box”, the topic object extraction unit 204 estimates both the objects 301a and 301c as topic object candidates with higher likelihood than the other objects. In such a case, to uniquely determine a topic object with higher accuracy, the topic object extraction unit 204 may use various feature amounts such as a spatial feature amount and a modality feature amount. In the example illustrated in FIG. 6, the topic object extraction unit 204 uniquely determines a topic object using a spatial feature amount and a modality feature amount.

A spatial feature amount is a feature amount based on the concept that a topic object appears larger, closer to the center, and more clearly (in focus) in the image. In the example illustrated in FIG. 6, the topic object extraction unit 204 includes a not-illustrated spatial feature amount encoder.

In step S113, the topic object extraction unit 204 inputs the topic object information to the spatial feature amount encoder and acquires a spatial feature amount as the output of the spatial feature amount encoder.

A modality feature amount is a feature amount based on the concept that in a case where there is a pointing object that points to a topic object in the image, the topic object is identified with high accuracy by utilizing the modality of the pointing object. In the example illustrated in FIG. 6, the topic object extraction unit 204 includes a not-illustrated modality feature amount encoder.

In step S114, the topic object extraction unit 204 detects the hand 302 as a pointing object. In such a case, the topic object is likely to be present at the position or in the direction pointed by the hand 302 detected as a pointing object. In step S115, the topic object extraction unit 204 thus acquires a topic object presence probability map as a modality feature amount, using the modality feature amount encoder. For example, the topic object presence probability map outputs high scores at specific positions or in specific directions based on hand gestures.

In step S116, the topic object extraction unit 204 uniquely determines a topic object based on the topic object information acquired in step S111, the spatial feature amount acquired in step S113, and the modality feature amount acquired in step S115.

In the example illustrated in FIG. 5, the object 301a is captured in a larger size than the object 301c and located in a region where the topic object presence probability based on the modality of the hand 302 is high, and is thus more likely to be a topic object. In this case, the topic object extraction unit 204 thus determines the object 301a as the topic object between the objects 301a and 301c that are topic object candidates.

The foregoing is merely an example, and the feature amounts to be used in determining a topic object are not limited in particular as long as the feature amounts are extracted from the target image. As a specific example, the image quality of each of the objects included in the image (for example, a feature amount serving as an image quality evaluation index) may be used as a feature amount. In such a case, an object having higher image quality may be determined as the topic object among the objects included in the image, for example.

In step S117, the topic object extraction unit 204 outputs the result of extraction of the topic object, including position information about the topic object (object 301a) determined in step S116, to a predetermined output destination. The position information about the topic object may be output as position information about a rectangle (bounding box) enclosing the topic object, for example.

The application of such control can be expected to provide the effect of further improving the accuracy of topic object extraction.

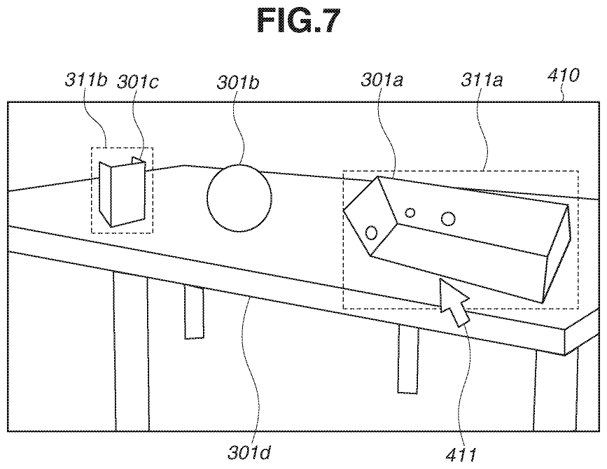

Another example of the display state of the target image display section 410 in the display screen 400 will be described with reference to FIG. 7. Rectangles 311a and 311b respectively enclosing the objects 301a and 301c that are topic object candidates based on the topic object information are displayed in the image displayed in the target image display section 410, in addition to the objects 301a to 301d. The user can select one of the objects 301a and 301c that are the topic object candidates as a topic object, using a pointer 411 via the input unit 101.

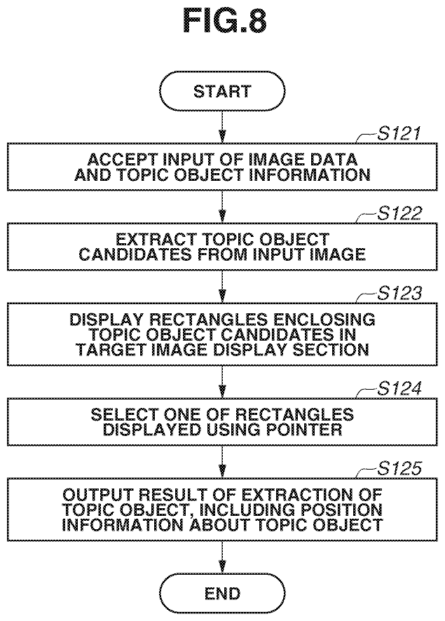

With the state illustrated in FIG. 7 as an example, processing in a case where the topic object extraction unit 204 uniquely determines a topic object via user input will be described with reference to FIG. 8 as another example of the processing by the topic object extraction unit 204.

In step S121, the image acquisition unit 201 accepts input of image data to be processed from the user. The utterance data acquisition unit 202 acquires utterance data indicating the user's utterance content. The text generation unit 203 generates topic object information and morphological modification factor information based on the utterance data acquired by the utterance data acquisition unit 202.

In step S122, based on the image data and the topic object information acquired in step S121, the topic object extraction unit 204 extracts topic object candidates indicated by the topic object information from the image (input image) represented by the image data.

In the example illustrated in FIG. 7, in a case where the acquired topic object name is “box”, the topic object extraction unit 204 estimates both the objects 301a and 301c as topic object candidates with higher likelihood than the other objects.

In step S123, the output control unit 207 displays the rectangles 311a and 311b respectively enclosing the objects 301a and 301c that are the topic object candidates in the target image display section 410 based on the result of estimation of topic object candidates in step S122.

In step S124, the topic object extraction unit 204 accepts selection of one of the rectangles 311a and 311b displayed in the target image display section 410, based on the pointer 411 operated by the user via the input unit 101.

In step S125, the topic object extraction unit 204 identifies the object corresponding to the rectangle selected in step S124 as the topic object, and outputs the result of extraction of the topic object, including the position information about the topic object, to a predetermined output destination. The position information about the topic object is output as position information about the rectangle (bounding box) enclosing the topic object, for example.

The application of such control enables more reliable identification of the topic object intended by the user.

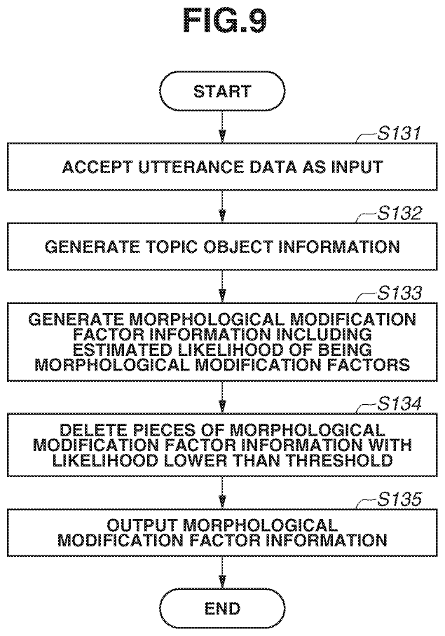

Referring to FIG. 9, an example of processing by the text generation unit 203 will be described, with focus on processing related to the extraction of morphological modification factors. In the example illustrated in FIG. 9, the text generation unit 203 filters morphological modification factors with a lower likelihood of faithfully reflecting the user's intention.

In step S131, the text generation unit 203 accepts utterance data (for example, utterance data acquired by the utterance data acquisition unit 202) as an input.

In step S132, the text generation unit 203 generates topic object information based on the utterance data accepted as an input in step S131.

In step S133, the text generation unit 203 generates morphological modification factor information based on the utterance data accepted as an input in step S131. The generated morphological modification factor information includes estimated likelihood of being morphological modification factors. Specifically, in a case where two morphological modification factors “move the round hole to the right” and “rotate gently” are extracted from the utterance data, the former has a higher likelihood of being a morphological modification factor, and the latter a lower likelihood.

In step S134, the text generation unit 203 compares the likelihood included in each piece of morphological modification factor information generated in step S133 with a threshold, and deletes pieces of morphological modification factor information with likelihood lower than the threshold.

In step S135, in a case where there is any piece of morphological modification factor information left undeleted as a result of the processing of step S134, the text generation unit 203 outputs the morphological modification factor information to a predetermined output destination.

As described above, the text generation unit 203 filters the morphological modification factor information, whereby subsequent processing for the pieces of morphological modification factor information deleted from the processing targets is omitted. A reduction in processing load and an improvement in processing speed can thus be expected. Since the information displayed in the morphological modification factor display section 450 of the display screen 400 is simplified, the effect of improving the user's convenience can also be expected.

On the other hand, the above-described technique can extract, from the utterance data, words that typically modify a morphology but have low relevance to the topic. For example, the topic object is “electronic board box”, and the text generation unit 203 generates pieces of morphological modification factor information corresponding to respective two morphological modification factors “move the round hole to the right” and “add taper to gear edges”. In this example case, although the topic object is “electronic board box” and the morphological modification factor “add taper to gear edges” is irrelevant to the topic, the morphological modification factor derived from the word seemingly related to morphological modification can be extracted with higher likelihood. In view of such a situation, another example of the technique related to the filtering of morphological modification factors will now be described.

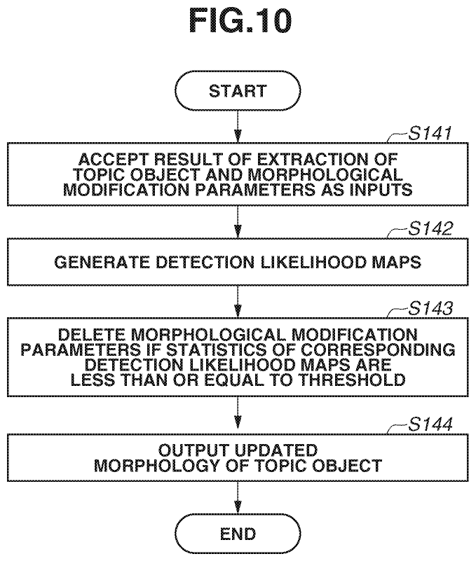

FIG. 10 is a flowchart illustrating an example of processing by the morphology update unit 206 according to the present embodiment. In the example illustrated in FIG. 10, to update the morphology of the topic object faithfully to the user's intention (make faithful modifications to the morphology), the morphology update unit 206 performs filtering of morphological modification factors having lower estimated likelihood of being morphological modification factors.

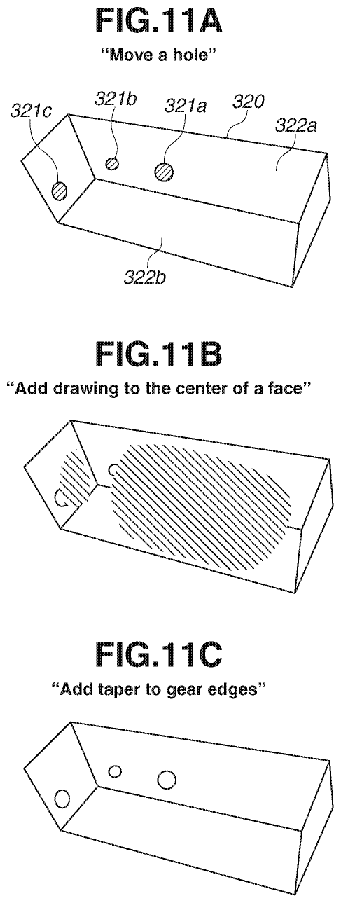

FIGS. 11A to 11C are schematic diagrams each illustrating an example of a detection likelihood map generated by the morphology update unit 206 according to the present embodiment. The detection likelihood map is a map indicating where in the image a detection target is present with what probability. Details of the detection likelihood map will be separately described below. In the example illustrated in FIGS. 11A to 11C, the topic object image 320 includes round hole portions 321a to 321c and flat portions 322a and 322b. In the example illustrated in FIGS. 11A to 11C, the topic object name is “electronic board box”, and FIGS. 11A, 11B, and 11C illustrate the summary names of respective different morphological modification parameters. Specifically, FIG. 11A corresponds to an example of a morphological modification parameter indicating “move a hole”, FIG. 11B “add drawing to the center of a face”, and FIG. 11C “add taper to gear edges”.

In step S141, the morphology update unit 206 accepts the result of extraction of the topic object including the topic object image and the morphological modification parameters as inputs. The morphological modification parameters inherit the morphological modification factor information, and include the summary names and attributes included in the morphological modification factor information likewise.

In step S142, the morphology update unit 206 executes a detection task for morphologies to be processed and generates detection likelihood maps based on the result of execution of the detection task, regardless of whether the attribute of the morphological modification parameter is addition, modification, or deletion.

In the example illustrated in FIG. 11A, given the morphological modification parameter “move a hole”, the morphology update unit 206 detects the round hole portions 321a to 321c from the topic object image 320. Here, the detection likelihood at locations corresponding to the respective round hole portions 321a to 321c is set to a higher value than at other locations. The hatched portions in the diagram represent regions where the detection likelihood is higher (regions where the detection likelihood is higher than or equal to a threshold, for example). The non-hatched portions represent regions where the detection likelihood is lower (regions where the detection likelihood is lower than the threshold, for example).

In the example illustrated in FIG. 11B, given the morphological modification parameter “add drawing to the center of a face”, the morphology update unit 206 detects the flat portions 322a and 322b from the topic object image 320. Here, the detection likelihood at locations corresponding to the flat portions 322a and 322b are set to a higher value than at other locations.

In the example illustrated in FIG. 11C, given the morphological modification parameter “add taper to gear edges”, the morphology update unit 206 performs processing for detecting gears from the topic object image 320. Since there is no gear in the example illustrated in FIGS. 11A to 11C, the detection likelihood is set to a lower value across the entire topic object image 320.

In step S143, the morphology update unit 206 calculates a predetermined statistic (for example, a maximum value) based on each of the detection likelihood maps generated in step S142. In a case where the statistic is less than or equal to a threshold, the morphology update unit 206 deletes the morphological modification parameter corresponding to the detection likelihood map.

In step S144, in a case where there is any piece of morphological modification parameter left undeleted as a result of the processing of step S143, the morphology update unit 206 updates the morphology of the topic object based on the morphological modification parameter, and outputs the update result to a predetermined output destination.

Through the series of processes described above, the topic object image and the morphological modification parameters are matched, and filtering processing using the statistics of the detection likelihood maps of the morphological modification parameters is performed. This prevents a morphology to which a morphological modification factor not originally intended by the user is applied from being output, and enables updating the morphology of the topic object more faithfully to the user's intention.

Next, an example of a method for generating morphological modification parameters more accurately reflecting the user's intention through interactive processing via the display unit 102 and the input unit 101 will be described.

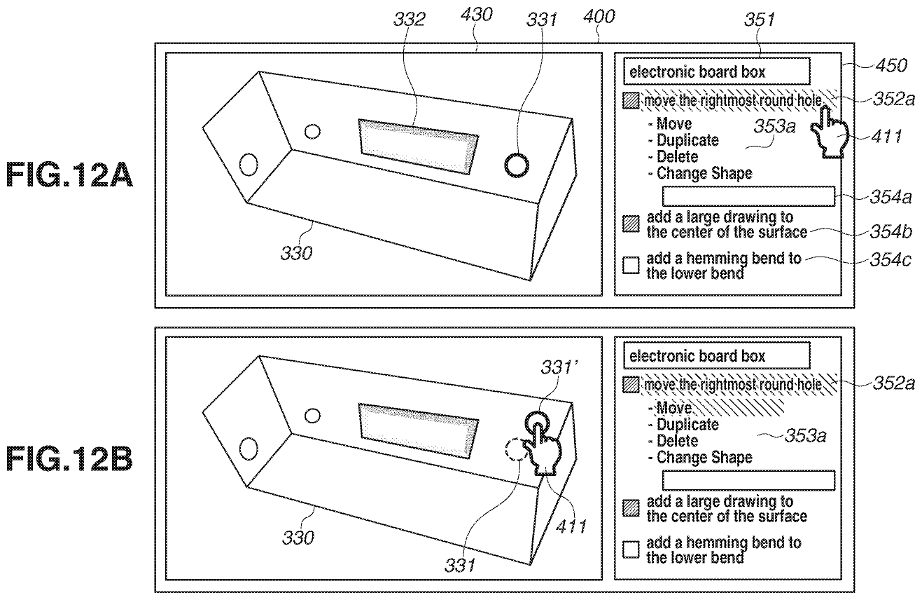

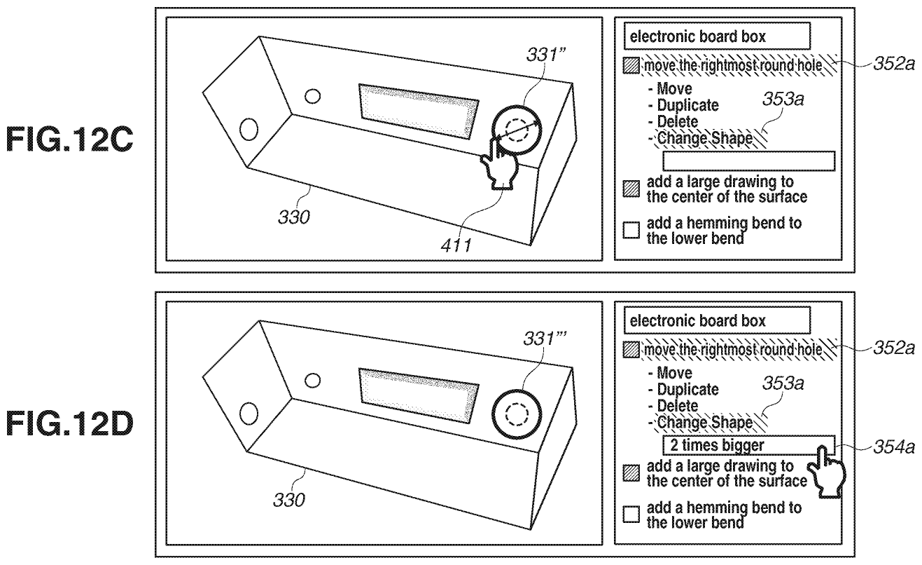

FIGS. 12A to 12D are diagrams illustrating other examples of a screen that the information processing apparatus 100 according to the present embodiment presents to the user via the display unit 102. The display screen 400 illustrated in each of FIGS. 12A to 12D includes the update result display section 430 and the morphological modification factor display section 450. A pointer 411 to be used to specify a part of the display screen 400 is also displayed based on user operation accepted via the input unit 101. In the examples illustrated in FIGS. 12A to 12D, the morphological modification factor display section 450 displays the three morphological modification factors (summary names) 352a to 352c. The morphological modification factor 352a represents a morphological modification “move the rightmost round hole”. The morphological modification factor 352b represents a morphological modification “add a large drawing to the center of the surface”. The morphological modification factor 352c represents a morphological modification “add a hemming bend to the lower bend”.

In the example illustrated in FIG. 12A, the user can select any morphological modification factor in the morphological modification factor display section 450. For example, the user selects the morphological modification factor 352a representing the morphological modification “move the rightmost round hole” in the example illustrated in FIG. 12A. In this case, a command list 353a for performing predetermined processes is displayed for the selected morphological modification factor 352a. In the example illustrated in FIG. 12A, the command list 353a displays commands for applying processes such as “move”, “duplicate”, “delete”, and “change shape” to the morphological feature based on the morphological modification factor.

More detailed conditions may be specifiable for at least some of the commands. For example, in the example illustrated in FIG. 12A, a text box 354a for accepting a new shape specification in the form of text information is displayed for the command “change shape”.

With such a configuration, substantially the same usability can be enjoyed as in the case of using an information processing apparatus that automatically generates a morphology based on the foregoing utterance data.

FIG. 12B schematically illustrates an example of a state where the command “move” is selected by the user for the morphological modification factor 352a representing the morphological modification “move the rightmost round hole”. With the command “move” selected by the user, the arrangement of the round hole portion 331 that is the morphological feature based on the target morphological modification factor 352a is set to be movable by a drag operation or the like using the pointer 411. In the example illustrated in FIG. 12B, the updated morphology 330 of the topic object has a round hole portion 331′, which is the round hole portion 331 moved by the foregoing operation.

FIG. 12C schematically illustrates an example of a state where the command “change shape” is selected by the user for the morphological modification factor 352a representing the morphological modification “move the rightmost round hole”. With the command “change shape” selected, the contour line of the round hole portion 331 that is the morphological feature based on the target morphological modification factor 352a is movable by a drag operation or the like using the pointer 411. In the example illustrated in FIG. 12C, the updated morphology 330 of the topic object has a round hole portion 331″, which is the round hole portion 331 changed in size by pulling its contour line outward.

FIG. 12D schematically illustrates another example of the state where the command “change shape” is selected by the user for the morphological modification factor 352a representing the morphological modification “move the rightmost round hole”. With the command “change shape” selected, instructions related to a change in the shape of the round hole portion 331 can be entered via the text box 354a.

In the example illustrated in FIG. 12D, an instruction to double the size of the round hole portion 331 is entered via the text box 354a. The updated morphology 330 of the topic object has a round hole portion 331′″, which is the round hole portion 331 changed in size based on the instruction input to the text box 354a.

The application of such control enables the user to set the geometric morphological information, such as position, size, shape, and orientation of morphological features based on morphological modification factors, in a manner that reflects their intention. While the foregoing description has focused mainly on the case of making corrections to geometric morphological information, the target of correction is not limited to geometric morphological information alone. As a specific example, appearance information such as color and texture can also be targeted for correction through application of substantially the same control as the foregoing.

### Second Embodiment

A second embodiment of the present disclosure will now be described. The present embodiment deals with an example of a configuration where results of modifications being made to a topic object based on morphological modification factor information are stored in a predetermined storage area, and the information stored in the storage area is made available for subsequent use. The present embodiment will be described with focus on portions particularly different from those of the foregoing first embodiment. A detailed description of portions substantially the same as those of the first embodiment will be omitted.

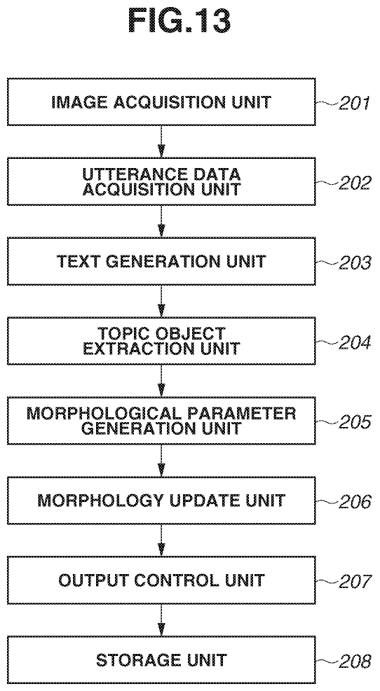

An example of a functional configuration of an information processing apparatus 100 according to the present embodiment will be described with reference to FIG. 13. The information processing apparatus 100 according to the present embodiment differs from the information processing apparatus 100 according to the first embodiment described with reference to FIG. 2 in that a storage unit 208 is included.

The storage unit 208 is a storage area for storing various types of data. There are mainly two types of data to be stored in the storage unit 208. A first type of data is training data for the information processing apparatus 100 to learn correlations between morphological modification factors and morphological modification parameters user by user, so that the users' intentions are more accurately reflected in making modifications to a topic object. A second type of data is history data indicating update results stored as a history so that the user can quickly check the results of the morphology of a topic object being updated by adding, modifying, or deleting morphological features of the topic object.

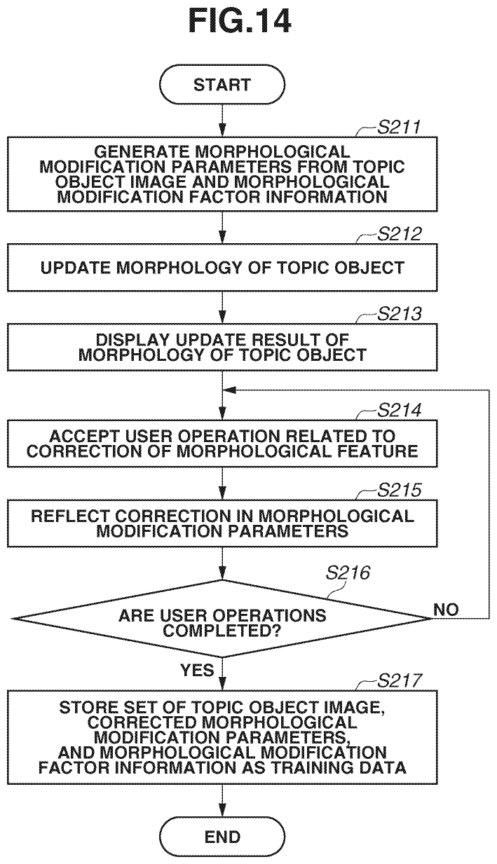

An example of processing by the information processing apparatus 100 according to the present embodiment will initially be described with reference to FIG. 14, with focus on processing related to storage of the foregoing training data. FIG. 14 illustrates an example of a series of processes from the processing related to generation of morphological modification parameters by the morphological parameter generation unit 205 onward.

In step S211, the morphological parameter generation unit 205 generates morphological modification parameters based on a topic object image and morphological modification factor information accepted as inputs.

In step S212, the morphology update unit 206 updates the morphology of the topic object so that the morphology has morphological features based on the morphological modification parameters generated in step S211.

In step S213, the output control unit 207 displays the update result of the morphology of the topic object in step S212 in a predetermined display area. As a specific example, the output control unit 207 may display a display screen 400 on a display unit 102, and display the update result of the morphology of the topic object in an update result display section 430 of the display screen 400.

In step S214, the morphological parameter generation unit 205 accepts a user operation related to correction of a morphological feature as to the update result of the morphology of the topic object, displayed in a predetermined display area in step S213. As described above with reference to FIGS. 12A to 12D, the morphological parameter generation unit 205 here may accept operations related to correction of a morphological feature of the topic object from the user through interactive processing via the display 102 and an input unit 101.

In step S215, the morphological parameter generation unit 205 performs processing related to correction of the morphological modification parameters generated in step S211 to follow the operation related to the correction of the morphological feature of the topic object, accepted from the user in step S214.

The following is a specific example in which a morphological feature is added by “add a hole”, a morphological modification parameter “shape” corresponding morphological modification factor information is a circle, and the user corrects the shape of the target hole to a rectangle. In such a case, the morphological parameter generation unit 205 changes the “shape” field of the morphological modification parameters to a rectangle.

In step S216, the morphological parameter generation unit 205 determines whether user operations are completed.

If, in step S216, the morphological parameter generation unit 205 determines that user operations are not completed (NO in step S216), the processing proceeds to step S214. In such a case, the processing of steps S214 and S215 is performed again. The morphological parameter generation unit 205 thus accepts a user operation related to correction of morphological features of the topic object and performs the processing related to the correction of the morphological modification parameters based on the user operation each time, until user operations are completed.

If, in step S216, the morphological parameter generation unit 205 determines that user operations are completed (YES in step S216), the processing proceeds to step S217.

In step S217, the output control unit 207 stores a set of the topic object image, the morphological modification parameters corrected through the processing of steps S214 to S216, and the morphological modification factor information from which the morphological modification parameters are generated into the storage unit 208 as training data.

The training data generated thus is segmented into user-by-user data and used to train the morphological parameter generation unit 205. This enables the morphological parameter generation unit 205 to generate morphological modification parameters closer to the users' intentions.

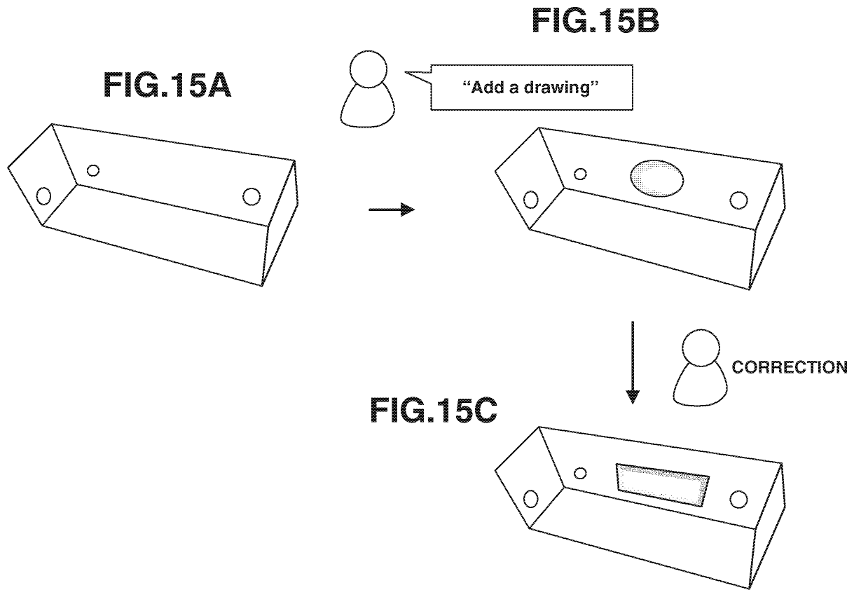

The processing described with reference to FIG. 14 will now be described in more detail with reference to FIGS. 15A to 15C by citing a specific example.

FIG. 15A schematically illustrates a topic object image to be processed. For example, a user makes an utterance indicating an instruction “add a drawing” for the topic object image illustrated in FIG. 15A. In such a case, based on the utterance data indicating the user's utterance content, the result of the modification made to the morphology of the topic object is displayed in a predetermined display area as illustrated in FIG. 15B. In the state illustrated in FIG. 15B, the user further makes an operation related to correction of the drawing, and the result reflecting the correction to the drawing in the morphology of the topic object is displayed as illustrated in FIG. 15C.

In FIG. 15B, the morphological parameter generation unit 205 generates morphological modification parameters indicating that the drawing has a round shape, and the result of the morphological feature in the morphology of the topic object being modified as indicated by the morphological modification parameters is displayed. Meanwhile, since the morphological feature is corrected as illustrated in FIG. 15C, it is obvious that the drawing intended by the user in the example illustrated in FIGS. 15A to 15C is rectangular in shape. Based on such a result, the target topic object image, the morphological modification factor information, and the morphological modification parameters (morphological modification parameters reflecting the correction based on the user's instructions) are stored in the storage unit 208 as training data.

Using this training data to train the morphological parameter generation unit 205 enables the morphological parameter generation unit 205 to learn that when an instruction to add a drawing to a box-shaped component is given, the morphological modification parameter “shape” is rectangular.

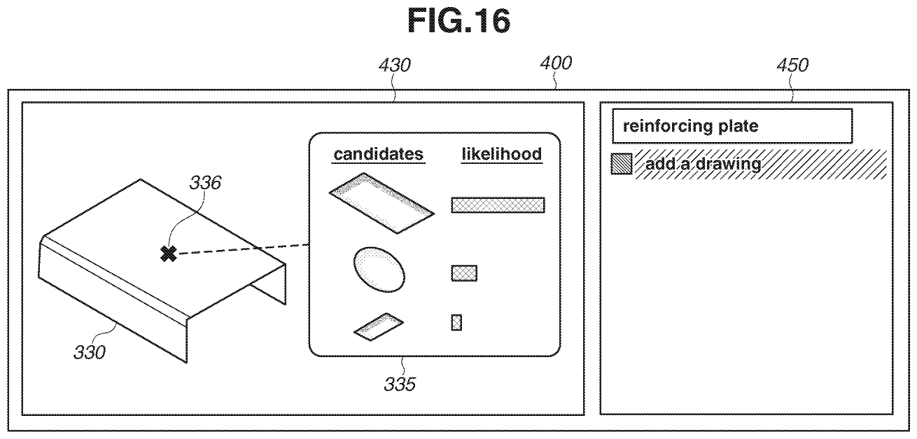

An example of the display screen of the information processing apparatus 100 according to the present embodiment will be described with reference to FIG. 16. For example, the morphological parameter generation unit 205 trained based on the training data described with reference to FIGS. 15A to 15C is applied here.

In the example illustrated in FIG. 16, the display screen 400 includes the update result display section 430 and a morphological modification factor display section 450. The update result display section 430 displays a topic object “reinforcing plate”, and the morphological modification factor display section 450 displays an instruction “add a drawing”. Based on the morphological modification factor instruction, the update result display section 430 further displays a marker 336 indicating the center position at which to generate the morphology, and a morphology candidate window 335 for selecting the shape, size, and orientation of the morphology to be applied from candidates. The morphology candidate window 335 also displays, for each of the morphology candidates to be selected, likelihood corresponding to the estimated likelihood of that candidate being selected by the target user.

In the example illustrated in FIG. 16, given the instruction “add a drawing”, the estimated likelihood of the rectangular drawing is the highest since the morphological parameter generation unit 205 is trained using the training data generated based on the conditions illustrated in FIGS. 15A to 15C.

In such a manner, the morphology candidate window 335 preferentially displays candidates for which higher likelihood is estimated by the morphological parameter generation unit 205 that is trained using user-by-user training data. The application of such control enables the user to select a morphology candidate closer to their intention more easily from a group of candidates presented on the morphology candidate window 335.

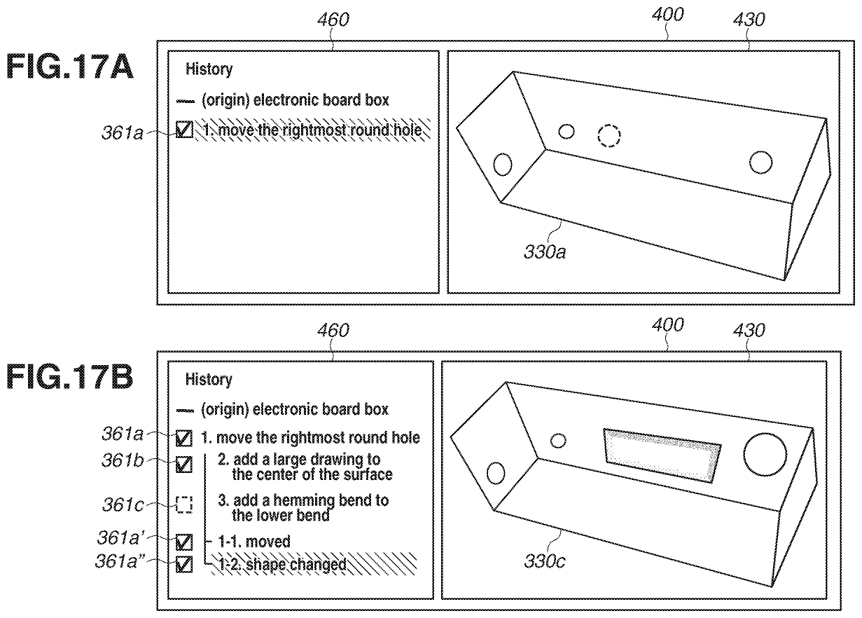

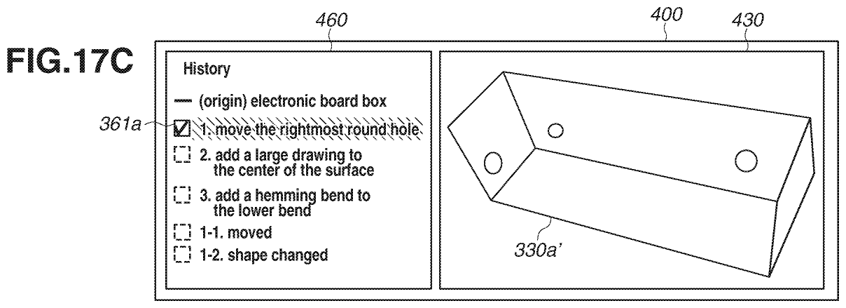

Next, history data stored in the storage unit 208 based on update results of the morphology of a topic object will be described. FIGS. 17A to 17C are diagrams each illustrating an example of the display screen 400 of the information processing apparatus 100 according to the present embodiment. FIGS. 17A to 17C illustrate the state of the display screen 400 in chronological order, where FIG. 17A illustrates the oldest state and FIG. 17C the newest. The display screen 400 illustrated in FIGS. 17A to 17C includes the update result display section 430 and a history display section 460.

The state illustrated in FIG. 17A will initially be described. In the state illustrated in FIG. 17A, only a morphological modification factor 361a is selected to be applied. The update result display section 430 thus displays a morphology 330a of the topic object updated by reflecting the morphological feature indicated by the morphological modification factor 361a. Here, the history display section 460 reflects information indicating that the morphological modification factor 361a is applied. In this case, the updated morphology 330a of the topic object and the morphological modification factor 361a are linked with each other and stored in the storage unit 208 as history data.

In the example illustrated in FIGS. 17A to 17C, the selection states of morphological modification factors and morphological modification parameters in the history display section 460 are displayed as the selection states of checkboxes. Furthermore, when the selection states are switched between selected and non-selected through operation of the checkboxes, whether to apply the respective morphological modification factors and morphological modification parameters is selectively switched.

Next, the state illustrated in FIG. 17B will be described. In the state illustrated in FIG. 17B, morphological modification factors 361a and 361b and morphological modification parameters 361a′ and 361a″ are selected to be applied. The update result display section 430 thus displays a morphology 330c of the topic object updated by reflecting morphological features indicated by the respective morphological modification factors 361a and 361b and the respective morphological modification parameters 361a′ and 361a″. Here, the history display section 460 reflects information indicating that the morphological modification factors 361a and 361b and the morphological modification parameters 361a′ and 361a″ are applied. In this case, the updated morphology 330c of the topic object, the morphological modification factors 361a and 361b, and the morphological modification parameters 361a′ and 361a″ are linked with each other and stored in the storage unit 208 as history data.

Next, the state illustrated in FIG. 17C will be described. In the state illustrated in FIG. 17C, the checkboxes for the morphological modification factors and the morphological modification parameters other than the morphological modification factor 361a are deselected. The update result display section 430 thus displays only a morphology 330a′ of the topic object updated by reflecting the morphological feature of only the morphological modification factor 361a among the series of morphological modification factors and morphological modification parameters presented in the history display section 460. Here, the output control unit 207 checks whether history data about the updated morphology 330a linked with only the morphological modification factor 361a is stored in the storage unit 208. In the example illustrated in FIGS. 17A to 17C, the history data on the updated morphology 330a linked with only the morphological modification factor 361a is stored in the storage unit 208 when in the state illustrated in FIG. 17A. The output control unit 207 thus displays the updated morphology 330a in the update result display section 430 based on this history data stored in the storage unit 208, without the intervention of the morphology update unit 206.

As a possible use case of the present embodiment, the user may check the updated morphologies of a target object by selectively switching whether to apply each of various morphological modification factors specified before to comparatively examine the morphologies of the object. Even in such a case, the present embodiment eliminates the need to generate the updated morphologies of the topic object again in a case where the history data is stored. This allows the processing related to the display of the updated morphology of the topic object to thus be accelerated. Furthermore, since the updated morphologies of the topic object are displayed based on the history data, reproducibility of the morphologies of the topic object depending on the selection states of the morphological modification factors is also ensured.

### Other Embodiments

Although the embodiment examples have been described above in detail, the present disclosure may take, for example, the form of an embodiment as a system, an apparatus, a method, a program, or a recording medium (storage medium). Specifically, the present disclosure may be applied to a system composed of a plurality of devices (for example, a host computer, an interface device, an imaging apparatus, a web application, and the like), or may be applied to an apparatus composed of a single device.

It is also to be understood that the object of the present disclosure is achieved as follows. That is, a recording medium (or storage medium) storing program code (computer program) of software for implementing the functions of the above-described embodiments is supplied to a system or an apparatus. Such a storage medium is a computer-readable storage medium. Then, a computer (or a CPU or MPU) of the system or apparatus reads out and executes the program code stored in the recording medium. In this case, the program code itself read out from the recording medium implements the functions of the above-described embodiments, and the recording medium storing the program code constitutes the present disclosure.

The disclosure of the present embodiment includes the following configurations, method, and program.

### Configuration 1

An information processing apparatus comprising an acquisition unit configured to acquire topic object information and morphological modification factor information based on utterance data indicating an utterance content of a user's utterance, the topic object information indicating an object serving as a topic of the utterance content, the morphological modification factor information being information that is included in the utterance content and modifies a morphology of the object; a modification unit configured to make a modification, based on the morphological modification factor information, to the object corresponding to the topic object information acquired by the acquisition unit among one or more objects included in a target image of the user's utterance; and an output control unit configured to perform control to output a result of the modification made to the object by the modification unit to a predetermined output destination.

### Configuration 2

The information processing apparatus according to configuration 1, further comprising a generation unit configured to generate, based on the morphological modification factor information, a morphological modification parameter indicating a morphological feature of the object, wherein the modification unit is configured to make the modification to the object corresponding to the topic object information based on the morphological modification parameter.

### Configuration 3

The information processing apparatus according to configuration 2, wherein the modification made by the modification unit includes at least one of adding the morphological feature to the object corresponding to the topic object information, modifying at least a part of the object based on the morphological feature, and deleting the morphological feature from the object, based on the morphological modification parameter.

### Configuration 4

The information processing apparatus according to configuration 2 or 3, wherein the morphological modification parameter includes at least one of: morphological information including information about at least one of position, size, shape, and orientation; and appearance information including at least one of color and texture.

### Configuration 5

The information processing apparatus according to any one of configurations 2 to 4, wherein the morphological modification factor information includes, as an attribute, information indicating which modification to make to the object corresponding to the topic object information among a plurality of modifications including addition, deletion, and modification, and wherein the generation unit controls configuration of the morphological modification parameter to be generated based on the attribute included in the morphological modification factor information.

### Configuration 6

The information processing apparatus according to any one of configurations 2 to 5, wherein the morphological modification factor information includes at least one of a name of an object serving as the topic of the utterance content, an estimated likelihood of the object being the topic, applicability of the modification to the object, and information about the user making the utterance indicated by the utterance content.

### Configuration 7

The information processing apparatus according to configuration 6, wherein in a case where the estimated likelihood included in the morphological modification factor information is lower than a threshold, the modification based on the morphological modification factor information to the object corresponding to the topic object information is suppressed.

### Configuration 8

The information processing apparatus according to configuration 6, wherein in a case where a predetermined statistic acquired from a likelihood map is less than a threshold, the modification unit suppresses the modification based on the morphological modification factor information to the object corresponding to the topic object information, the likelihood map being based on the estimated likelihood included in the morphological modification factor information and indicating where in the target image of the user's utterance the object corresponding to the topic object information is present with what probability.

### Configuration 9

The information processing apparatus according to configuration 2, further comprising a storage unit configured to store morphological modification factor information and a morphological modification parameter generated based on the morphological modification factor information in association with each other as training data, wherein the generation unit generates a morphological modification parameter based on user information included in morphological modification factor information accepted as an input and the training data stored by the storage unit.

### Configuration 10

The information processing apparatus according to any one of configurations 2 to 9, wherein the output control unit controls display of the result of the modification made to the object in a predetermined display area, and wherein the predetermined display area includes a first partial area where the target image of the user's utterance is displayed, a second partial area where an image of the object corresponding to the topic object information is displayed, and a third partial area where an image corresponding to the result of the modification made to the object is displayed, and is configured so that whether to display the image in each of the first, second, and third partial areas is selectively switched.

### Configuration 11

The information processing apparatus according to configuration 10, wherein the third partial area is configured to accept an instruction related to the modification to the object corresponding to the topic object information from the user, and wherein the generation unit controls the morphological modification parameter to be applied to make the modification to the object corresponding to the topic object information based on the instruction accepted from the user at the third partial area.

### Configuration 12

The information processing apparatus according to configuration 10 or 11, wherein the predetermined display area includes a fourth partial area configured to accept selection of at least one of a series of pieces of morphological modification factor information acquired, and wherein the generation unit controls whether to add a modification to the object corresponding to the topic object information based on each of the series of pieces of morphological modification factor information accepted via the fourth partial area, depending on a selection state of each of the series of pieces of morphological modification factor information.

### Configuration 13

The information processing apparatus according to configuration 12, wherein the fourth partial area is configured to accept specification of processing to be applied to the selected piece of morphological modification factor information, the processing being configured to modify a morphological feature, and wherein the generation unit controls the morphological modification parameter to be applied to make the modification to the object corresponding to the topic object information based on the morphological modification factor information selected via the fourth partial area and the processing specified for the morphological modification factor information.

### Configuration 14

The information processing apparatus according to any one of configurations 2 to 13, further comprising: a retaining unit configured to sequentially retain, as a history, results of modifications made by the modification unit to the object based on acquisition results of the morphological modification factor information by the acquisition unit, and an acceptance unit configured to accept an instruction related to applicability of each of a series of pieces of morphological modification factor information acquired, wherein in a case where a result of a modification made by the modification unit to the object based on one or more pieces of morphological modification factor information for which the applicability-related instruction is accepted by the acceptance unit is retained as the history, the output control unit performs control to output the result indicated by the history to the predetermined output destination.

### Configuration 15

The information processing apparatus according to configuration 14, wherein the acceptance unit accepts an instruction related to applicability of each of one or more processes for modifying the morphological feature, the processes being targeted for at least one of the one or more pieces of morphological modification factor information for which the applicability-related instruction is accepted, and in a case where a result of the object being modified by the modification unit based on the one or more pieces of morphological modification factors for which the applicability-related instruction is accepted by the acceptance unit and the one or more processes for which the applicability-related instruction is accepted is retained as the history, the output control unit performs control to output the result indicated by the history to a predetermined output destination.

### Configuration 16

The information processing apparatus according to configuration 15, wherein in a case where a result of the object being modified based on the one or more pieces of morphological modification factor information for which the applicability-related instruction is accepted by the acceptance unit and a morphological modification parameter for which the applicability-related instruction is accepted among the series of morphological modification parameters is not retained as the history, the modification unit modifies the object corresponding to the topic object information based on the one or more pieces of morphological modification factor information and the morphological modification parameter for which the applicability-related instruction is accepted, and wherein the output control unit performs control to output the result of the object being modified by the modification unit to the predetermined output destination.

### Configuration 17

The information processing apparatus according to any one of configurations 1 to 16, wherein the utterance data includes at least one of text data input by the user and text data generated based on a recognition result of voice spoken by the user.

### Configuration 18

The information processing apparatus according to any one of configurations 1 to 17, wherein the modification unit extracts the object corresponding to the topic object information from the target image of the user's utterance based on at least one of feature amounts of one or more objects included in the image, and makes the modification based on the morphological modification factor information to the extracted object, the feature amounts including a spatial feature, image quality, and modality.

### Configuration 19

The information processing apparatus according to configuration 18, wherein in a case where there is a plurality of object candidates corresponding to the topic object information, the modification unit extracts at least one of the plurality of object candidates as the object corresponding to the topic object information based on an instruction from the user.

### Method 1

A control method of an information processing apparatus comprising acquiring topic object information and morphological modification factor information based on utterance data indicating an utterance content of a user's utterance, the topic object information indicating an object serving as a topic of the utterance content, the morphological modification factor information being information that is included in the utterance content and modifies a morphology of the object, making a modification, based on the morphological modification factor information, to the object corresponding to the topic object information acquired by the acquiring among one or more objects included in a target image of the user's utterance, and controlling output of a result of the modification made to the object to a predetermined output destination.

### Program 1

A program that causes a computer to function as an information processing apparatus comprising an acquisition unit configured to acquire topic object information and morphological modification factor information based on utterance data indicating an utterance content of a user's utterance, the topic object information indicating an object serving as a topic of the utterance content, the morphological modification factor information being information that is included in the utterance content and modifies a morphology of the object, a modification unit configured to make a modification, based on the morphological modification factor information, to the object corresponding to the topic object information acquired by the acquisition unit among one or more objects included in a target image of the user's utterance, and an output control unit configured to control output of a result of the modification made by the modification unit to the object to a predetermined output destination.

According to the present disclosure, the morphology of an object indicated by the content of the user's utterance is reproduced in a more suitable manner.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

1. An information processing apparatus comprising:
at least one processor; and
at least one memory having stored thereon instructions which, when executed by the at least one processor, cause the information processing apparatus at least to:
acquire topic object information and morphological modification factor information based on utterance data indicating an utterance content of a user's utterance, the topic object information indicating an object serving as a topic of the utterance content, the morphological modification factor information being information that is included in the utterance content and modifies a morphology of the object;
generate, based on the morphological modification factor information, a morphological modification parameter indicating a morphological feature of the object corresponding to the topic object information among one or more objects included in a target image of the user's utterance;
make a modification to the object based on the morphological modification parameter; and
control output of a result of the modification made to the object to a predetermined output destination,
wherein the morphological modification factor information includes at least one of an estimated likelihood of the object being the topic, applicability of the modification to the object, and information about the user making the utterance indicated by the utterance content.

2. The information processing apparatus according to claim 1, wherein the modification includes at least one of adding the morphological feature to the object corresponding to the topic object information, modifying at least a part of the object based on the morphological feature, and deleting the morphological feature from the object, based on the morphological modification parameter.

3. The information processing apparatus according to claim 1, wherein the morphological modification parameter includes at least one of: morphological information including information about at least one of position, size, shape, and orientation; and appearance information including at least one of color and texture.

4. The information processing apparatus according to claim 1,
wherein the morphological modification factor information includes, as an attribute, information indicating which modification to make to the object corresponding to the topic object information among a plurality of modifications including addition, deletion, and modification, and
wherein configuration of the morphological modification parameter to be generated is controlled based on the attribute included in the morphological modification factor information.

5. The information processing apparatus according to claim 4, wherein in a case where the estimated likelihood included in the morphological modification factor information is lower than a threshold, the modification based on the morphological modification factor information to the object corresponding to the topic object information is suppressed.

6. The information processing apparatus according to claim 4, wherein in a case where a predetermined statistic acquired from a likelihood map is less than a threshold, the modification based on the morphological modification factor information to the object corresponding to the topic object information is suppressed, the likelihood map being based on the estimated likelihood included in the morphological modification factor information and indicating where in the target image of the user's utterance the object corresponding to the topic object information is present with what probability.

7. The information processing apparatus according to claim 1, wherein the information processing apparatus is further caused to:
store morphological modification factor information and a morphological modification parameter generated based on the morphological modification factor information in association with each other as training data; and
generate a morphological modification parameter based on user information included in morphological modification factor information accepted as an input and the stored training data.

8. The information processing apparatus according to claim 1,
wherein the information processing apparatus is further caused to control display of the result of the modification made to the object in a predetermined display area, and
wherein the predetermined display area includes a first partial area where the target image of the user's utterance is displayed, a second partial area where an image of the object corresponding to the topic object information is displayed, and a third partial area where an image corresponding to the result of the modification made to the object is displayed, and is configured so that whether to display the image in each of the first, second, and third partial areas is selectively switched.

9. The information processing apparatus according to claim 8,
wherein the third partial area is configured to accept an instruction related to the modification to the object corresponding to the topic object information from the user, and
wherein the morphological modification parameter to be applied to make the modification to the object corresponding to the topic object information is controlled based on the instruction accepted from the user at the third partial area.

10. The information processing apparatus according to claim 8,
wherein the predetermined display area includes a fourth partial area configured to accept selection of at least one of a series of pieces of morphological modification factor information acquired, and
wherein whether to add a modification to the object corresponding to the topic object information based on each of the series of pieces of morphological modification factor information accepted via the fourth partial area is controlled depending on a selection state of each of the series of pieces of morphological modification factor information.

11. The information processing apparatus according to claim 10,
wherein the fourth partial area is configured to accept specification of processing to be applied to the selected piece of morphological modification factor information, the processing being configured to modify a morphological feature, and
wherein the morphological modification parameter to be applied to make the modification to the object corresponding to the topic object information is controlled based on the morphological modification factor information selected via the fourth partial area and the processing specified for the morphological modification factor information.

12. The information processing apparatus according to claim 1,
wherein the information processing apparatus is further caused to:
sequentially retain, as a history, results of modifications made to the object based on acquisition results of the morphological modification factor information; and
accept an instruction related to applicability of each of a series of pieces of morphological modification factor information acquired,
wherein in a case where a result of a modification made to the object based on one or more pieces of morphological modification factor information for which the applicability-related instruction is accepted is retained as the history, output of the result indicated by the history to the predetermined output destination is controlled.

13. The information processing apparatus according to claim 12, wherein the information processing apparatus is further caused to:
accept an instruction related to applicability of each of one or more processes for modifying the morphological feature, the processes being targeted for at least one of the one or more pieces of morphological modification factor information for which the applicability-related instruction is accepted; and
in a case where a result of the object being modified based on the one or more pieces of morphological modification factors for which the applicability-related instruction is accepted and the one or more processes for which the applicability-related instruction is accepted is retained as the history, control output of the result indicated by the history to a predetermined output destination.

14. The information processing apparatus according to claim 13, wherein the information processing apparatus is further caused to, in a case where a result of the object being modified based on the one or more pieces of morphological modification factor information for which the applicability-related instruction is accepted and a morphological modification parameter for which an applicability-related instruction is accepted among a series of morphological modification parameters is not retained as the history, modify the object corresponding to the topic object information based on the one or more pieces of morphological modification factor information and the morphological modification parameter for which the applicability-related instruction is accepted, and control output of the result of the object being modified to the predetermined output destination.

15. The information processing apparatus according to claim 1, wherein the utterance data includes at least one of text data input by the user and text data generated based on a recognition result of voice spoken by the user.

16. The information processing apparatus according to claim 1, wherein the information processing apparatus is further caused to extract the object corresponding to the topic object information from the target image of the user's utterance based on at least one of feature amounts of one or more objects included in the image, and make the modification based on the morphological modification factor information to the extracted object, the feature amounts including a spatial feature, image quality, and modality.

17. The information processing apparatus according to claim 16, wherein in a case where there is a plurality of object candidates corresponding to the topic object information, at least one of the plurality of object candidates is extracted as the object corresponding to the topic object information based on an instruction from the user.

18. A control method of an information processing apparatus comprising:
acquiring topic object information and morphological modification factor information based on utterance data indicating an utterance content of a user's utterance, the topic object information indicating an object serving as a topic of the utterance content, the morphological modification factor information being information that is included in the utterance content and modifies a morphology of the object;
generating, based on the morphological modification factor information, a morphological modification parameter indicating a morphological feature of the object corresponding to the topic object information among one or more objects included in a target image of the user's utterance;
making a modification to the object based on the morphological modification parameter; and
controlling output of a result of the modification made to the object to a predetermined output destination,
wherein the morphological modification factor information includes at least one of an estimated likelihood of the object being the topic, applicability of the modification to the object, and information about the user making the utterance indicated by the utterance content.

19. A non-transitory computer-readable storage medium storing a program that causes a computer to function as an information processing apparatus comprising:
an acquisition unit configured to acquire topic object information and morphological modification factor information based on utterance data indicating an utterance content of a user's utterance, the topic object information indicating an object serving as a topic of the utterance content, the morphological modification factor information being information that is included in the utterance content and modifies a morphology of the object;
a generation unit configured to generate, based on the morphological modification factor information, a morphological modification parameter indicating a morphological feature of the object corresponding to the topic object information among one or more objects included in a target image of the user's utterance;
a modification unit configured to make a modification to the object based on the morphological modification parameter; and
an output control unit configured to control output of a result of the modification made to the object to a predetermined output destination,
wherein the morphological modification factor information includes at least one of an estimated likelihood of the object being the topic, applicability of the modification to the object, and information about the user making the utterance indicated by the utterance content.
